(19) United States
(12) Patent Application Publication
(10) Pub. No.: US 2011/0066559 A1
(43) Pub. Date: Mar. 17, 2011

(54) METHOD AND SYSTEM FOR PROVIDING AUTOMATED TROUBLE TICKET STATUS NOTIFICATIONS

(75) Inventors: Chris White, Plano, TX (US); Robert Scherer, Newport, NC (US); Duane Whitsett, Tulsa, OK (US); Evan Pedersen, Colorado Springs, CO (US)

(73) Assignee: VERIZON PATENT AND LICENSING INC., Basking Ridge, NJ (US)

(21) Appl. No.: 12/560,124

(22) Filed: Sep. 15, 2009

(51) Int. Cl. G06Q 10/00; G06N 5/02; G06F 17/30

(52) U.S. Cl. 705/304; 706/47; 707/802; 706/46; 707/E17.044

(57) ABSTRACT

An approach for automatically generating a status update for events on a trouble ticket is provided. Events on the trouble ticket monitored and a determination is made whether an event triggers a predetermined status update criteria. A status update is generated upon triggering of the predetermined status update criteria.

### BACKGROUND OF THE INVENTION

Modern communication systems involve a delicate interplay of network components that support voice and data services. These systems are vital to business operations, such that downtime imposes a significant cost to the business. The impact of network failures (even very minor ones lasting only minutes) can be measured in thousands or even millions of dollars. Therefore, customers are acutely aware of problems that arise with such systems and have a vested interest in ensuring that such problems are resolved in a timely manner.

Networks may utilize trouble ticket systems as an efficient manner in which to keep track of problem events that arise in the system, and to keep track of the steps being taken to resolve such problems. In order to obtain the current status of such trouble tickets, a customer may contact a customer service representative of the service provider, as to have the representative access and relay the status of the trouble ticket. Furthermore, due to the impact that such problem events can have on the operation of the customer's business, the customer may repeatedly and frequently contact the customer service center, which can place a heavy burden on the resources of such a customer service center. Additionally, such a situation can be frustrating to customers that do not have any other means of determining whether the problem is in the process of being resolved, and may feel as though the problem is being overlooked by the service provider.

Based on the foregoing, there is a need for an automated trouble ticket status notification method and system that can provide customers with access to updates on the status of trouble tickets.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of an architecture for providing automated trouble ticket status notification, according to various embodiments;

FIG. 2 is a diagram of a trouble ticket status update system and communication platform for use with a service provider network for providing automated trouble ticket status notification, according to various embodiments;

FIG. 3 is a flowchart of a status update summary process, according to various embodiments;

FIG. 4 is a flowchart of a process for a customer to specify notification parameters for a trouble ticket status update system, according to various embodiments;

FIG. 5 is a graphical representation of a status update summary history for a particular trouble ticket, according to one embodiment;

FIG. 6A depicts a summary view of the current milestone status, and FIG. 6B depicts a detailed milestone log that includes historical events that have occurred for the trouble ticket, according to one embodiment; and

FIG. 7 is a diagram of a computer system that can be used to implement various embodiments.

### DESCRIPTION OF THE PREFERRED EMBODIMENT

An apparatus, method, and software for providing fault isolation and/or resolution as part of a managed services network are described. In the following description, for the purposes of explanation, numerous specific details are set forth in order to provide a thorough understanding of the present invention. It is apparent, however, to one skilled in the art that the present invention may be practiced without these specific details or with an equivalent arrangement. In other instances, well-known structures and devices are shown in block diagram form in order to avoid unnecessarily obscuring the present invention.

Although the various exemplary embodiments are described with respect to providing automated fault isolation and/or recovery in a managed services context, it is contemplated that these embodiments have applicability to systems operated solely by customer organizations.

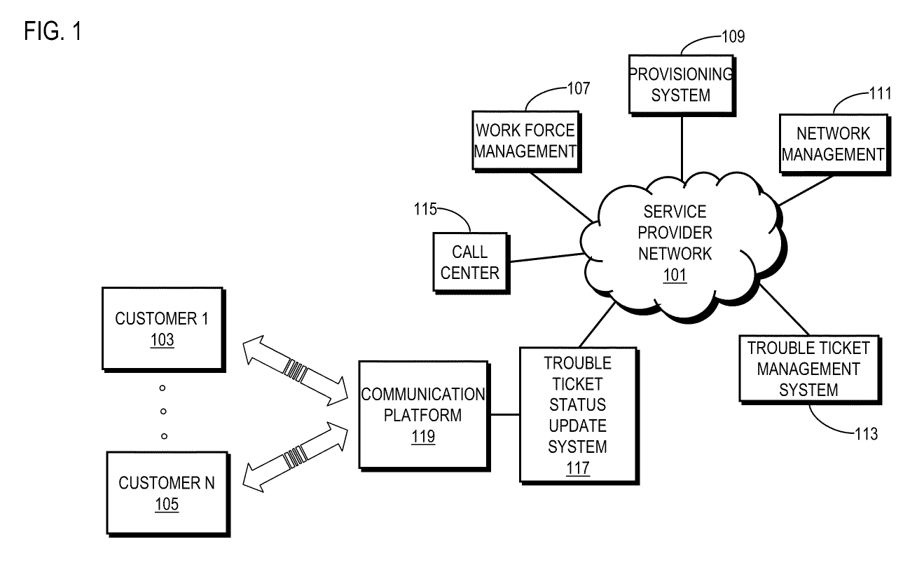

FIG. 1 is a diagram of an architecture for providing automated trouble ticket status notification for use, for example, with a service provider network 101 that is configured to provide media content or communication services (e.g., voice, data, video, etc.) to various customers (or subscribers), such as customer₁ 103 . . . customer_{N} 105. The customer can be an individual or residence that receives one or more media services from the service provider network 101, either directly or from a content provider via the service provider network 101. The customer could also be an entity, such as a corporation, enterprise, or organization, that receives one or more media services from the service provider network 101, either directly or from a content provider via the service provider network 101. The various communication conduits used to provide one or more media services to the various customers are not expressly depicted in FIG. 1, and can include the use of any form of wired or wireless communication architecture (e.g., land-line, cable, fiber optic, satellite-based, cellular, or other communication architecture).

The service provider network 101 in FIG. 1 includes a workforce management module or unit 107, a provisioning system 109, and a network management module or unit 111. The workforce management 107 monitors and controls allocation of workforce to perform various tasks needed to provide customers with the services, such as set-up and maintenance of customer's services. The provisioning system 109 monitors and controls the provisioning of various network resources to particular customers, and the network management 111 manages the various network assets.

In order to process various customer problems and concerns that arise with the customer's services, the service provider network 101 includes a trouble ticket management system 113 and a call center 115. The trouble ticket management system 113 allows for the creation of a trouble ticket for a customer problem, which can be used to track the steps being taken to resolve the problem. In order to determine the status of the actions being taken with regard to a problem, the customer can contact a customer service representative at the call center 115, and the customer service representative can access the trouble ticket management system in order to determine the status of the trouble ticket. However, the embodiment depicted in FIG. 1 advantageously includes a trouble ticket status update system 117 that can provide automated updating and reporting of trouble ticket status to customers via a communication platform 119. Although shown as separate systems, the trouble ticket management system 113 and the trouble ticket status update system 117 can be integrated into a single platform in an alternative embodiment.

In terms of customer satisfaction, it is beneficial for the service provider network 101 to provide customers with the most up-to-date status of the trouble ticket as possible. Additionally, in terms of efficient utilization of resources, it is also beneficial for the service provider network 101 to provide customers with automated access to the status of the trouble ticket. For example, due to the fact that service-downtime can have dramatic effects on a customer entity's ability to conduct business, a corporate customer may repeatedly contact a call center 115 to determine the status of the trouble ticket, in a system that does not include an automated trouble ticket status update system. Such a situation can result in an extremely heavy volume of calls to a call center, which requires that the service provider network employ and provide the needed resources to a large number of call center employees in order to process such calls.

The trouble ticket status update system 117 and communication platform 119 allow a customer to obtain the status on a trouble ticket without the need to talk to an agent in an inbound call center. The trouble ticket status update system 117, which can either be provided as a separate unit from (as shown in FIG. 1) or as a unit integrated within the trouble ticket management system 113, can automatically monitor the repair progress of trouble tickets and determine the current status summary by noting, e.g., date and time the ticket is created, analysis of test results, reason why a ticket is on hold and pending dispatch, overall time to repair, when the last update was made to the ticket, etc. The customer can access such status summary information whenever desired, and/or can be automatically apprised (i.e., without a request by the customer) of such status summary either on a periodic basis or on an event-triggered basis, as desired by the customer.

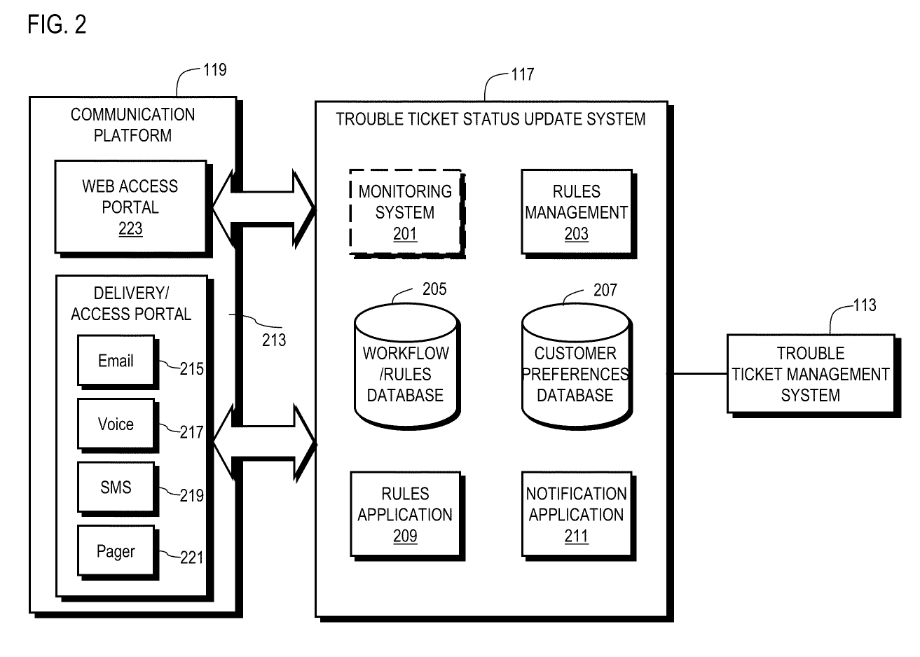

FIG. 2 is a diagram of an embodiment of the trouble ticket status update system 117 and the communication platform 119 for use with a service provider network for providing automated trouble ticket status notification.

The trouble ticket status update system 117 includes a monitoring system 201, which can either be integrated as part of the system 117 or a separate unit therefrom, a rules management module 203, a workflow/rules database 205, a customer preferences database 207, a rules application module 209, and a notification application module 211.

The monitoring system 201 is used to monitor events that occur in the trouble ticket management system 113 for analysis using the trouble ticket status update system 117.

The rules management module 203 allows a manager to create, define, modify, and delete rules and workflows that determine when an event in the trouble ticket management system 113 triggers a status summary update and/or communication with the customer. The workflow/rules database 205 stores the various workflows and rules. Engineers, for example, can identify exactly what has to happen to trigger the new event (e.g., events can only be triggered by certain workgroups, types of users, or a person), and/or there can be exceptions built into the system, for example, conditional logic can bet applied to the new trigger.

The customer preferences database 207 stores the customer's preference regarding the manner in which they receive or access status summary updates, for example, the portal via which the prefer to receive or access such updates (e.g., via email, voice, short message service (SMS), pager, web, etc.), their contact information, the frequency of updates (e.g., on a periodic basis at a certain interval, on a event basis, etc.).

The rules application module 209 receives the event updates detected by the monitoring system 201 and applies the triggering criteria from the workflow/rules database 205 to determine if a status summary update has been triggered. The notification application module 211 receives the triggered status summary updates determined by the rules application module 209 and applies the customer preferences from the customer preferences database 207 to determine if and in what manner a status summary update should be communicated to or made available to the customer via the communication platform 119.

Further, the communication platform 119 is provided to allow for automated status summary messages to be sent to the customer upon initiation of the trouble ticket status update system 117, or for the customer to contact the trouble ticket status update system 117 to retrieve messages. Such messages can be presented to the customer as either a one way communication, or can provide the customer with the ability to communicate further information to the system 117 and/or request and retrieve additional information (e.g., using web links, or telephone menus, contact email addresses, etc.).

The communication platform 119 includes a delivery/access portal 213 having an email portal 215, a voice portal 217, an SMS portal 219, and a pager portal 221. The communication platform 119 also includes a web access portal 223. The communication portal 119 allows trouble ticket status update system 117 to automatically send status summary updates to the customer, and/or allows the customer to proactively access and retrieve such status summary updates via such automated portals 213, 223 as desired by the customer. For example, upon updating of the status summary, the notification application 211 could direct a telephone communication to the customer contact number that provides an automated voice message indicating the updated status summary, and could provide the customer with a series of interactive menus that allow the customer to take further actions with regard to the trouble ticket or to obtain further information about the status summary, etc. Similarly, such updates could be available to the customer via email, SMS text, pager, or web access portal, based on the customer's preferences.

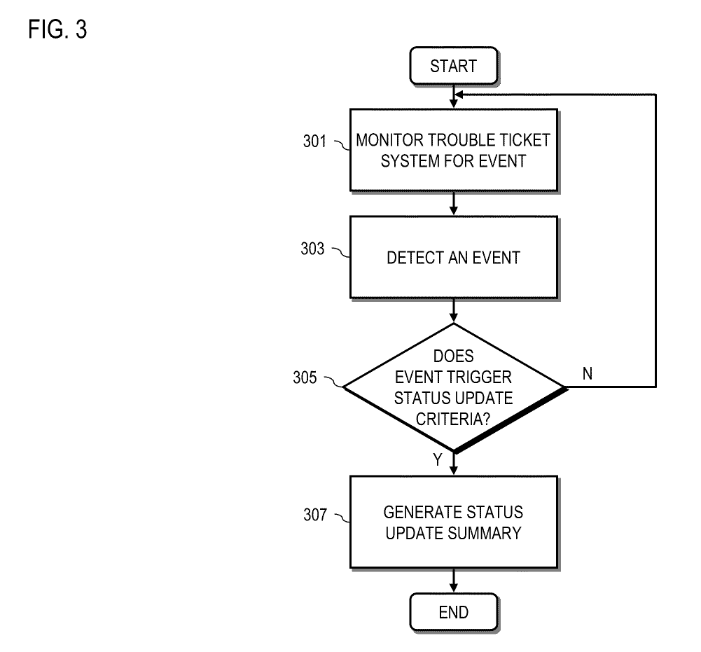

FIG. 3 is a flowchart of a status update summary process, according to various embodiments. In step 301, the monitoring system 201 monitors for events that occur in the trouble ticket management system 113. In step 303, the monitoring system 201 detects an event. In step 305, the rules application module 209 receives the event updates detected by the monitoring system 201 and applies the triggering criteria from the workflow/rules database 205 to determine if a status summary update has been triggered. As mentioned previously, the rules management module 203 allows a manager to create, define, modify, and delete rules and workflows that determine when an event in the trouble ticket management system 113 triggers a status summary update and/or communication with the customer, for example, when it rises to a level that a customer would be interested in being apprised of such an event. If the event is determined to not trigger a status update criteria, then the process loops back to step 301, but if the event is determined to trigger the status update criteria, then the process proceeds to step 307. In step 307, the notification application module 211 receives the triggered status summary updates, determined by the rules application module 209, and applies the customer preferences from the customer preferences database 207 to determine if and in what manner a status summary update should be communicated to or made available to the customer via the communication platform 119. Based on these determinations, the notification application module 211 generates the status update summary and makes the status update summary available to the customer, for example, by transmitting the status update summary to the customer via the delivery/access portal 213, or posting the status update summary on the web access portal 223.

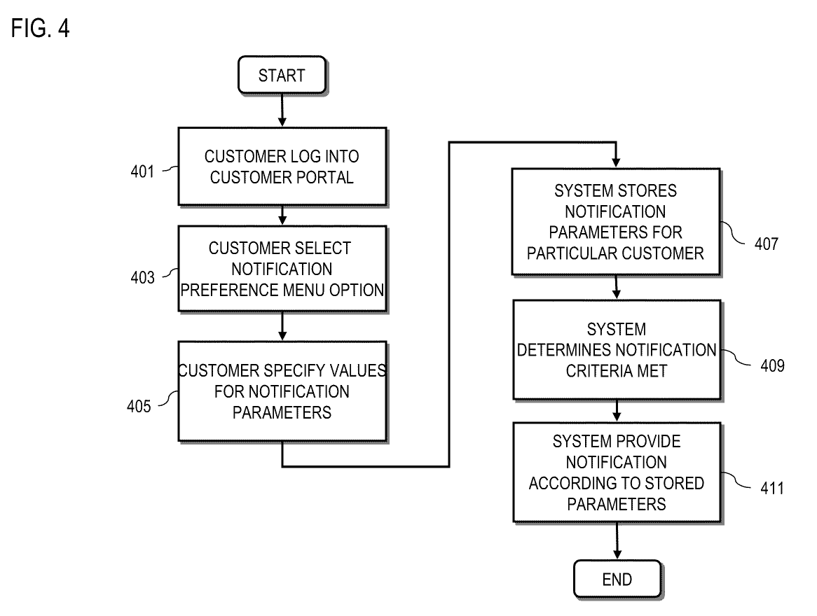

FIG. 4 is a flowchart of a process for a customer to specify notification parameters for a trouble ticket status update system, according to various embodiments. The service provider can enable the customer to have significant control of the manner in which such notifications are provided. The following exemplary scenario depicts how a customer can input the necessary notification parameters for receiving these notifications.

As shown, in step 401, a customer (e.g., personnel within of the customer network) logs into the web access portal 223, which sends a notification preference menu option to the customer via a browser interface, such as a web browser. The customer selects, as in step 403, the notification menu option and specifies values for the notification parameters shown as part of the menu option (step 405). The web access portal 223 stores the notification parameters for the particular customer specified by the customer in the customer preferences database 207, per step 407. In step 409, the trouble ticket status update system 117 determines if the notification criteria are met using the rules application module 209 and the notification application module 211, and, in step 411, the trouble ticket status update system 117 provides notification to the customer according to the parameters stored in the customer preferences database 207.

The trouble ticket status update system 117 can dramatically improve the customer experience for the customer. As soon as a trouble ticket is resolved, customers can make faster business decisions based on information at their fingertips. Also, the customer does not need to continuously contact the service provider in order to obtain information regarding the status of a trouble ticket, or to verify that action is being taken to resolve the outstanding problem associated with the trouble ticket. The service provider can also increase their reputation for customer service, and reduce call center staff and can even reduce telephone costs, since as staff will not need to keep customers on the phone as long when resolving their problem.

As noted above, engineers can identify exactly what has to happen to trigger a new event. Also, exceptions to the triggering of a status update summary can be provided in the system using conditional logic that applies to a trigger. A table of triggering events and various exceptions can be stored in the workflow/rules database 205 for use by the rules application module 209 to determine if a triggering event has occurred. For example, the engineers can define a trigger identification (mapping of the business logic) such that the trigger contains the mapping to the task and summary statement, define the task and a canned summary statement that is generated when the trigger is encountered, and generate a business rule that fires the trigger such that when the business rule evaluates to true, it fires the trigger.

Table 1 below shows an example of a table of trigger/event criteria, and canned summary status statements that can be generated upon triggering of a status update summary, which can be stored in the workflow/rules database 205. Table 1 shows various test milestones that could trigger a summary status statement.

TABLE 1
TEST MILESTONES

| TASK | SUMMARY STATUS STATEMENT | TRIGGER/EVENT CRITERIA |
|---|---|---|
| Queue for | Ticket <tkt num> has been | Ticket Referred or Transferred to any |
| Auto-Analysis | routed for Auto-Analysis | workgroup that starts with ‘ITS.’. |
| | | (example is ITS.PROD) |
| Auto-Analysis | Business is performing diagnostics | Workgroup ID: ITS.* Activity - |
| in Progress | regarding ticket <tkt num> | USER = ITSPROD performs |
| | to determine the problem. | Acknowledge activity |
| Test Clean | Testing regarding ticket <ticket num> | User = ITSPROD |
| | indicated no problems on the Business | Activity ITS sends an ADD comment |
| | network with regards to your service. | with Comment type of TEST CLEAN |
| Test is | Testing for ticket <tkt num> indicates | User = ITSPROD |
| Inconclusive | there could be a problem on the | Activity - ITS sends an ADD comment |
| | Business network. | with Comment type of TEST |
| | Further analysis is required. | INCONCLUSIVE |
| Network Issue | Testing for ticket <tkt num> indicates a | User = ITSPROD |
| | problem on the Business network. | Activity - ITS sends an ADD comment |
| | Further analysis is required. | with Comment type of NETWORK |
| | | ISSUE |
| Working to | Business is working to isolate the | User = ITSPROD |
| Isolate | problem for ticket <tkt num>. | Activity - ITS sends an ADD |
| | | COMMENT activity with a comment |
| | | type of “Unable to Auto Test” |
| Intermittent | Testing and analysis for ticket <tkt | User = ITSPROD |
| Hits | num> shows intermittent errors | Activity - ITS sends an ADD comment |
| | which require further | with the comment type of |
| | troubleshooting by Business. | Intermittent Hits |

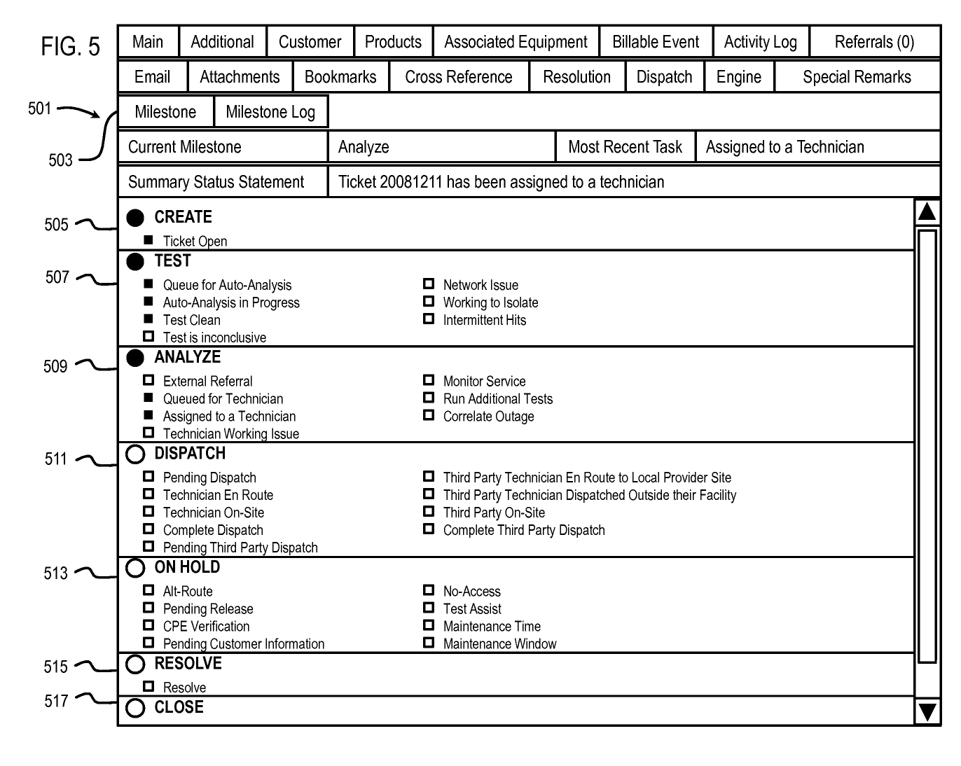

FIG. 5 depicts a graphical representation of a status update summary history for a particular trouble ticket. In this example, the customer can access a graphical user interface 501 via, for example, the web access portal 223, which will allow the customer to view the history of the status of the trouble ticket. As can be seen in FIG. 5, the customer can select on various tabs at the top of the graphical user interface 501, such as a milestone tab 503, which shows a summary of various major milestone events that can be reached during the processing of a trouble ticket.

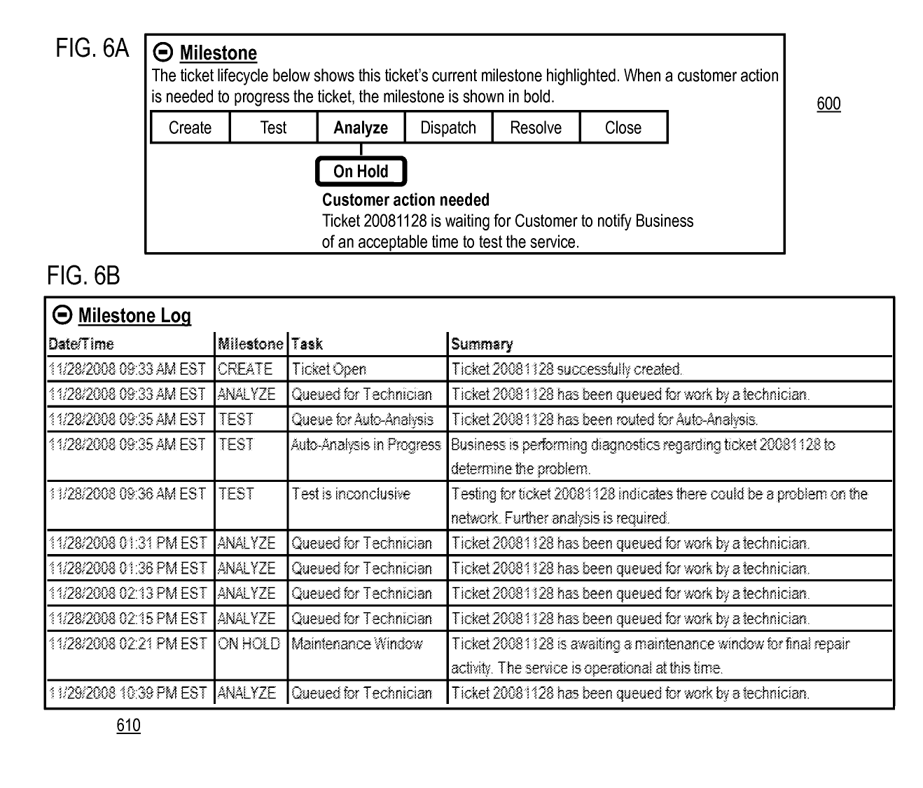

In the example depicted in FIG. 5, seven major milestones are defined, and thirty-four related summary status item can be triggered. The exemplary major ticket milestones are shown in various windows, such as a “create” milestone 505, a “test” milestone 507, an “analyze” milestone 509, a “dispatch” milestone 511, an “on hold” milestone 513, a “resolve” milestone 515, and a “close” milestone 517. In addition, FIG. 6A depicts a screen 600 providing a summary view of the current milestone status, and FIG. 6B depicts a screen 610 providing a detailed milestone log that the customer can select in order to obtain the historical events that have occurred for the trouble ticket.

Specific, significant, events on a ticket trigger tasks or events which fall underneath specific milestones. When these events occur, the user interface is updated to include the latest milestone and summary status update. For example, when an auto-tester sends a trigger to indicate that a circuit has tested clean, the user interface will be updated so that the “Test Clean” task/event has occurred under the test milestone 507. These significant events can be used to automatically update the customer and prevent incoming calls from the customer. As noted previously, these updates can be sent to the customer through a number of channels (e.g., e-mail, voice portal (automated calls), pager, SMS, etc.) based on customer preference.

Accordingly, a customer can view a graphical representation of the history on a repairs engine tab on the web access portal, or customers who are calling in for status on tickets can also hear the latest status via an inbound voice portal. After a customer enters their ticket number, the voice portal looks up the most recent update and plays a pre-recorded message which correlates to the status. Thus, the data engine can successfully take information which was previously added to the ticket in the form of comments and turn it into useful data. Prior to such a system, and the various mechanisms to deliver such data, call center employees would have to read the tickets, summarize the information to give to the customer either through inbound customer calls, or making outbound contact with the customer. The new system allows for status to be provided to the customer via inbound calls, and automatically sending updates to the customer upon the occurrence of significant ticket events.

Also, the system can be configured to allow a customer to escalate a ticket, to report that an issue still exists on a ticket, to confirm that their service is restored or confirm resolution of a ticket, to add a comment to a ticket, to re-open an existing ticket, to report a new issue, to unsubscribe from receiving notifications for a ticket, or to send a communication (e.g., an e-mail) to a customer service representative or technician regarding a ticket. All of these features will help the service provider to reduce calls into the call centers, and thereby make the trouble ticket system more economically cost-efficient.

One of ordinary skill in the art would recognize that the processes described above may be implemented via software, hardware (e.g., general processor, Digital Signal Processing (DSP) chip, an Application Specific Integrated Circuit (ASIC), Field Programmable Gate Arrays (FPGAs), etc.), firmware, or a combination thereof. Such exemplary hardware for performing the described functions is detailed below.

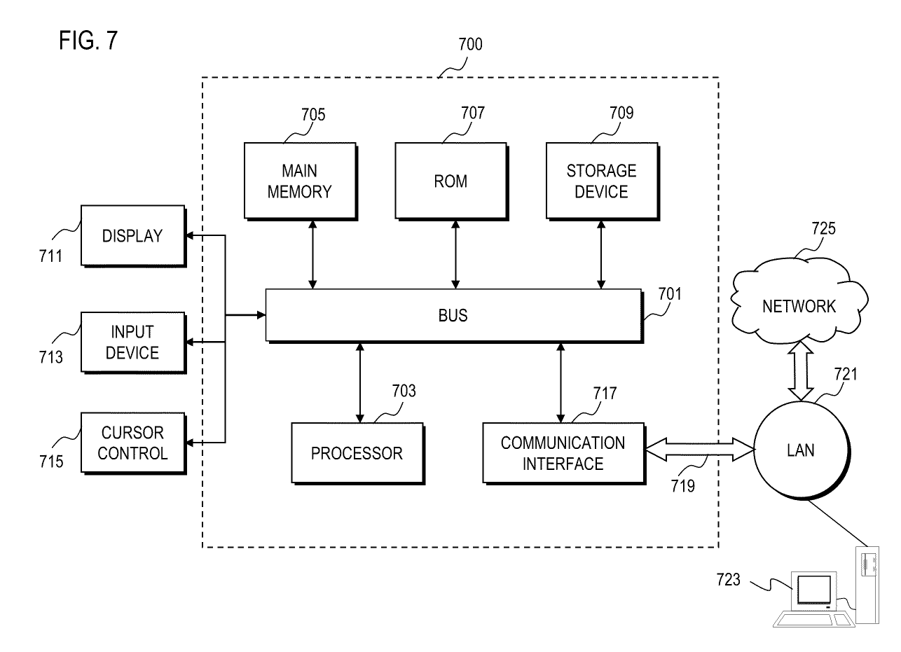

FIG. 7 illustrates a computer system 700 upon which an embodiment according to the present invention can be implemented. The computer system 700 includes a bus 701 or other communication mechanism for communicating information and a processor 703 coupled to the bus 701 for processing information. The computer system 700 also includes main memory 705, such as a random access memory (RAM) or other dynamic storage device, coupled to the bus 701 for storing information and instructions to be executed by the processor 703. Main memory 705 can also be used for storing temporary variables or other intermediate information during execution of instructions by the processor 703. The computer system 700 may further include a read only memory (ROM) 707 or other static storage device coupled to the bus 701 for storing static information and instructions for the processor 703. A storage device 709, such as a magnetic disk or optical disk, is coupled to the bus 701 for persistently storing information and instructions.

The computer system 700 may be coupled via the bus 701 to a display 711, such as a cathode ray tube (CRT), liquid crystal display, active matrix display, or plasma display, for displaying information to a computer user. An input device 713, such as a keyboard including alphanumeric and other keys, is coupled to the bus 701 for communicating information and command selections to the processor 703. Another type of user input device is a cursor control 715, such as a mouse, a trackball, or cursor direction keys, for communicating direction information and command selections to the processor 703 and for controlling cursor movement on the display 711.

According to one embodiment of the invention, the processes described herein are performed by the computer system 700, in response to the processor 703 executing an arrangement of instructions contained in main memory 705. Such instructions can be read into main memory 705 from another computer-readable medium, such as the storage device 709. Execution of the arrangement of instructions contained in main memory 705 causes the processor 703 to perform the process steps described herein. One or more processors in a multi-processing arrangement may also be employed to execute the instructions contained in main memory 705. In alternative embodiments, hard-wired circuitry may be used in place of or in combination with software instructions to implement the embodiment of the present invention. Thus, embodiments of the present invention are not limited to any specific combination of hardware circuitry and software.

The computer system 700 also includes a communication interface 717 coupled to bus 701. The communication interface 717 provides a two-way data communication coupling to a network link 719 connected to a local network 721. For example, the communication interface 717 may be a digital subscriber line (DSL) card or modem, an integrated services digital network (ISDN) card, a cable modem, a telephone modem, or any other communication interface to provide a data communication connection to a corresponding type of communication line. As another example, communication interface 717 may be a local area network (LAN) card (e.g. for Ethernet™ or an Asynchronous Transfer Model (ATM) network) to provide a data communication connection to a compatible LAN. Wireless links can also be implemented. In any such implementation, communication interface 717 sends and receives electrical, electromagnetic, or optical signals that carry digital data streams representing various types of information. Further, the communication interface 717 can include peripheral interface devices, such as a Universal Serial Bus (USB) interface, a PCMCIA (Personal Computer Memory Card International Association) interface, etc. Although a single communication interface 717 is depicted in FIG. 7, multiple communication interfaces can also be employed.

The network link 719 typically provides data communication through one or more networks to other data devices. For example, the network link 719 may provide a connection through local network 721 to a host computer 723, which has connectivity to a network 725 (e.g. a wide area network (WAN) or the global packet data communications network now commonly referred to as the “Internet”) or to data equipment operated by a service provider. The local network 721 and the network 725 both use electrical, electromagnetic, or optical signals to convey information and instructions. The signals through the various networks and the signals on the network link 719 and through the communication interface 717, which communicate digital data with the computer system 700, are exemplary forms of carrier waves bearing the information and instructions.

The computer system 700 can send messages and receive data, including program code, through the network(s), the network link 719, and the communication interface 717. In the Internet example, a server (not shown) might transmit requested code belonging to an application program for implementing an embodiment of the present invention through the network 725, the local network 721 and the communication interface 717. The processor 703 may execute the transmitted code while being received and/or store the code in the storage device 709, or other non-volatile storage for later execution. In this manner, the computer system 700 may obtain application code in the form of a carrier wave.

The term “computer-readable medium” as used herein refers to any medium that participates in providing instructions to the processor 703 for execution. Such a medium may take many forms, including but not limited to non-volatile media, volatile media, and transmission media. Non-volatile media include, for example, optical or magnetic disks, such as the storage device 709. Volatile media include dynamic memory, such as main memory 705. Transmission media include coaxial cables, copper wire and fiber optics, including the wires that comprise the bus 701. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the present invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

While the present invention has been described in connection with a number of embodiments and implementations, the present invention is not so limited but covers various obvious modifications and equivalent arrangements, which fall within the purview of the appended claims. Additionally, the features of the present invention can be combined in a numerous combinations and permutations, in which the appended claims are illustrative in nature.

What is claimed is:

1. A method comprising:
monitoring for events on a trouble ticket;
determining whether an event triggers a predetermined status update criteria; and
automatically generating a status update upon triggering of the predetermined status update criteria.

2. The method according to claim 1, further comprising transmitting the status update to a customer upon generation of the status update.

3. The method according to claim 2, wherein the status update is transmitted via telephone, electronic mail, pager, and/or short message service.

4. The method according to claim 1, further comprising posting the status update on a web portal upon generation of the status update for retrieval by a customer.

5. The method according to claim 1, further comprising compiling a historical log of events on the trouble ticket that is accessible by the customer.

6. The method according to claim 1, further comprising receiving notification preferences from a customer, and providing the status update to the customer based upon the notification preferences.

7. The method according to claim 1, further comprising receiving updating information from a customer in response to the status update, and updating the trouble ticket based on the updating information.

8. An apparatus comprising:
a rules module configured to determine whether an event that occurred on a trouble ticket triggers a predetermined status update criteria; and
a notification module configured to automatically generate a status update upon triggering of the predetermined status update criteria.

9. The apparatus according to claim 8, further comprising a monitoring system configured to monitor for occurrence of the events on a trouble ticket.

10. The apparatus according to claim 8, wherein said notification module is configured to transmit the status update to a customer upon generation of the status update.

11. The apparatus according to claim 10, wherein said notification module is configured to transmit the status update via telephone, electronic mail, pager, and/or short message service.

12. The apparatus according to claim 8, wherein said notification module is configured to post the status update on a web portal upon generation of the status update for retrieval by a customer.

13. The apparatus according to claim 8, wherein said notification module is configured to compile a historical log of events on the trouble ticket that is accessible by the customer.

14. The apparatus according to claim 8, further comprising a customer preferences database configured to store notification preferences from a customer, wherein said notification module is configured to provide the status update to the customer based upon the notification preferences.

15. A system comprising:
a monitoring system configured to monitor for occurrence of the events on a trouble ticket;
a rules module configured to determine whether the event triggers a predetermined status update criteria; and
a notification module configured to automatically generate a status update upon triggering of the predetermined status update criteria,
wherein said notification module is configured to provide the status update to a customer upon generation of the status update.

16. The system according to claim 15, wherein said notification module is configured to transmit the status update via telephone, electronic mail, pager, and/or short message service to the customer.

17. The system according to claim 15, wherein said notification module is configured to post the status update on a web portal upon generation of the status update for retrieval by the customer.

18. The system according to claim 15, wherein said notification module is configured to compile a historical log of events on the trouble ticket that is accessible by the customer.

19. The system according to claim 15, further comprising a customer preferences database configured to store notification preferences from the customer, wherein said notification module is configured to provide the status update to the customer based upon the notification preferences.

20. The system according to claim 15, further comprising a trouble ticket system configured to issue and manage the trouble ticket, wherein the trouble ticket system is configured to receive updating information from the customer in response to the status update, and wherein the trouble ticket system is configured to update the trouble ticket based on the updating information.
